(19) United States
(12) Patent Application Publication
(10) Pub. No.: US 2009/0049254 A1
(43) Pub. Date: Feb. 19, 2009

(54) MEMORY CONTROLLER AND PROCESSOR SYSTEM

(75) Inventors: Syunsuke Koga, Fukuoka (JP); Tetsuji Shimogawa, Fukuoka (JP); Tadashi Nakano, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/184,553

(22) Filed: Aug. 1, 2008

(30) Foreign Application Priority Data
Aug. 13, 2007 (JP) 2007-210848

(51) Int. Cl. G06F 12/00

(52) U.S. Cl. 711/154; 711/168; 711/E12.001

(57) ABSTRACT

A memory controller includes a memory diagnosing part for controlling access from a CPU to a memory, and accessing and diagnosing the memory, an information setting part for setting cycle information according to a loaded condition of the CPU, and a cycle adjusting part for adjusting a cycle for the memory diagnosing part to access the memory based on the cycle information of the information setting part.

### CROSS-REFERENCE TO RELATED APPLICATIONS

This application is related to and claims priority to Japanese Patent Application No. 2007-210848 filed on Aug. 13, 2007, in the Japanese Patent Office, the entire contents of which are incorporated by reference herein.

### BACKGROUND

1. Field

The embodiment relates to a memory controller and a processor system, and to a memory controller and a processor system having a memory diagnosing function for accessing and diagnosing a memory.

2. Description of the Related Art

FIG. 1 is a block diagram of a general processor. As shown in FIG. 1, a memory controller 3 controls access from a CPU 1 to a memory 2. The CPU 1 is connected to a PCI bus 5 via a Pro-PCI bus bridge 4. PCI devices 6, 7 and the like are connected to the PCI bus 5.

FIG. 2 is a block diagram of a conventional memory controller. In FIG. 2, a memory patrol diagnosis requesting part 11 in the memory controller 3 corrects one-bit error and detects uncorrectable memory errors in the memory 2. An access controlling part 12 selects a memory access type, which indicates whether the memory access is from the CPU 1 or from the memory patrol diagnosis requesting part 11. The access controlling part 12 reports the type information to a data controlling part 13. The data controlling part 13 switches the memory access based on the information.

When the memory access from the CPU 1, which is shown in FIG. 2, and the memory access from the memory patrol diagnosis requesting part 11, which is shown in FIG. 2, contend with each other on the access controlling part 12, the access controlling part 12 selects whether to execute the memory access from the CPU 1 or the memory access from the memory patrol diagnosis requesting part 11 according to the contention timing. The access controlling part 12 sends the selection information on its selection to the data controlling part 13.

The conventional memory controller is adapted to process a memory access from the CPU 1 and a memory access from the memory patrol diagnosis requesting part 11 in the abovementioned manner. The memory patrol diagnosis requesting part 11 continuously issues diagnostic access requests without regard to the frequency of the memory access from the CPU 1.

FIG. 3 shows a processing sequence in a conventional configuration. A sequence SQ1 is a sequence in the case where a memory access from the CPU 1 and a memory access from the memory patrol diagnosis requesting part 11 do not contend with each other.

A sequence SQ3 in FIG. 3 is for the memory access contention in the case where the memory patrol diagnosis requesting part 11 issues a diagnostic access request while a memory access from the CPU 1 is being processed. In this case, as the memory access request from the CPU 1 is issued earlier than the diagnostic access request, the memory access from the CPU 1 is not delayed.

A sequence SQ2 in FIG. 3 is for the memory access contention in the case where the CPU 1 issues a memory access while a memory access according to a diagnostic access request is being processed. In this case, as the diagnostic access request is issued earlier than the memory access request from the CPU 1, the memory access from the CPU 1 is delayed for a time T1.

Japanese Patent Application Laid-Open Publication No. 2006-11576 describes a technique of detecting an error in a storage device by serially reading out the content of the storage device in an idle time of a control cycle and comparing that content with the content of a storage device in another system.

In the case of the sequence SQ2 in FIG. 3 where the CPU 1 issues a memory access while a memory access according to a diagnostic access request is being processed, as the diagnostic access request in the sequence SQ2 is issued earlier than the memory access request from the CPU 1, the memory access from the CPU 1 is delayed. That wait state of the memory access from the CPU 1 frequently occurs in a system with heavy load. Accumulated waiting time of the memory access from the CPU 1 delays program processing that is basically to be performed by the CPU 1 (memory access) in the system is delayed in total, which lowers the throughput of the system.

### SUMMARY

According to an aspect of an embodiment, a memory controller includes a memory diagnosing part for controlling access from a CPU to a memory and accessing and diagnosing the memory, an information setting part for setting cycle information according to a loaded condition of the CPU, and a cycle adjusting part for adjusting a cycle for the memory diagnosing part to access the memory based on the cycle information of the information setting part.

These together with other aspects and advantages which will be subsequently apparent, reside in the details of construction and operation as more fully hereinafter described and claimed, reference being had to the accompanying drawings forming a part hereof, wherein like numerals refer to like parts throughout.

The above-described embodiments of the present invention are intended as examples, and all embodiments of the present invention are not limited to including the features described above.

### BRIEF DESCRIPTION OF THE DRAWINGS

FIG. 1 is a block diagram of a general processor;

FIG. 2 is a block diagram of a conventional memory controller;

FIG. 3 is a processing sequence in a conventional configuration;

FIG. 4 is a block diagram of a memory controller according to an embodiment;

FIGS. 5A and 5B are processing sequences of a memory controller according to the embodiment;

FIG. 6 is a block diagram for illustrating a first embodiment;

FIG. 7 is a flowchart of a process to be executed by a software program according to the first embodiment;

FIG. 8 is a flowchart of a process to be executed by a software program according to a modification of the first embodiment;

FIG. 9 is a block diagram for illustrating a second embodiment;

FIG. 10 is a flowchart of a process to be executed by a software program according to the second embodiment;

FIG. 11 is a block diagram for illustrating a third embodiment;

FIG. 12 is a table showing cycle parameter table information;

FIGS. 13A and 13B are flowcharts of processes to be executed by a software program and a memory controller according to the third embodiment;

FIG. 14 is a block diagram for illustrating a fourth embodiment;

FIGS. 15A and 15B are flowcharts of processes to be executed by a software program and a memory controller according to the fourth embodiment;

FIG. 16 is a block diagram for illustrating a fifth embodiment;

FIGS. 17A and 17B are flowcharts of processes to be executed by a software program and a memory controller according to the fifth embodiment; and

FIGS. 18A and 18B are flowcharts of processes to be executed by a software program and a memory controller according to a modification of the fifth embodiment.

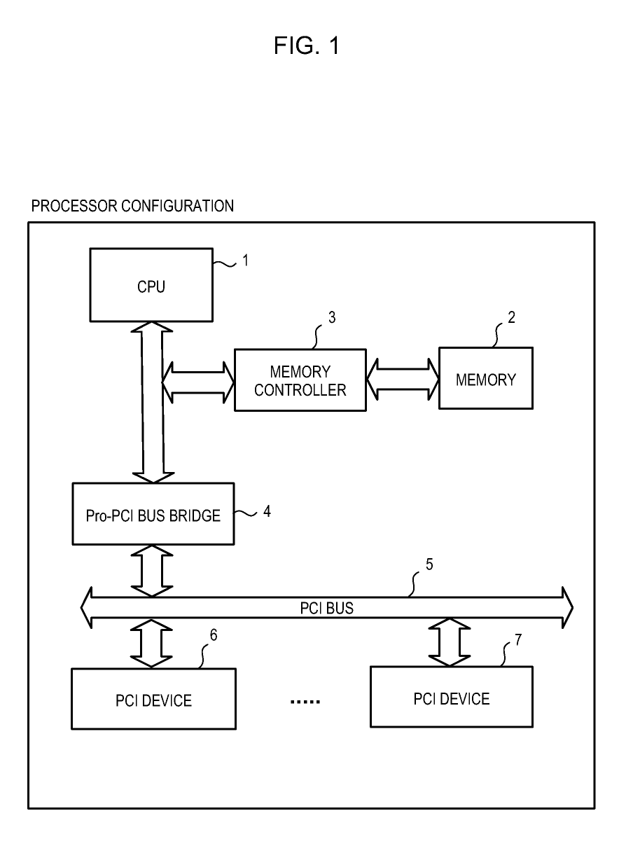

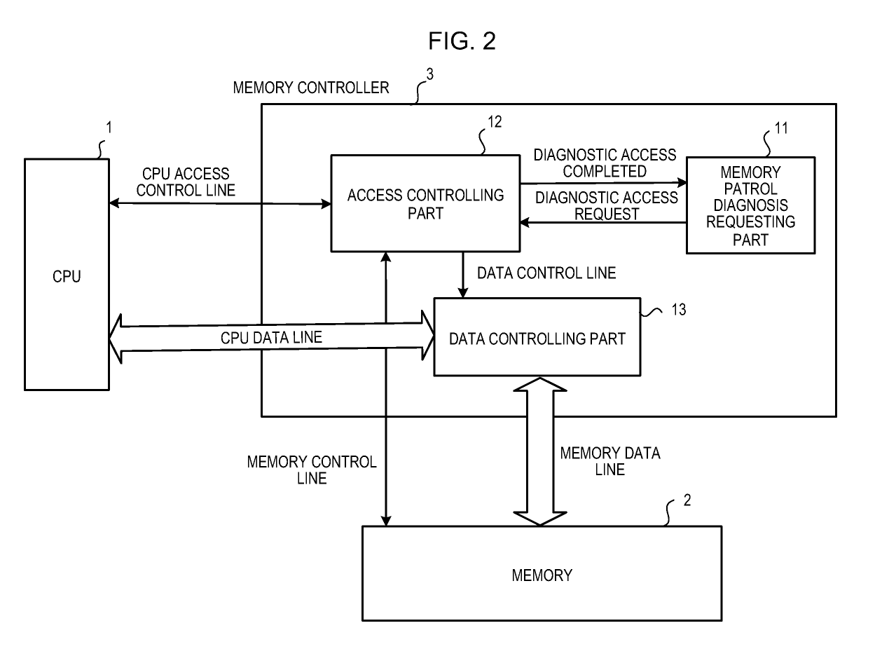

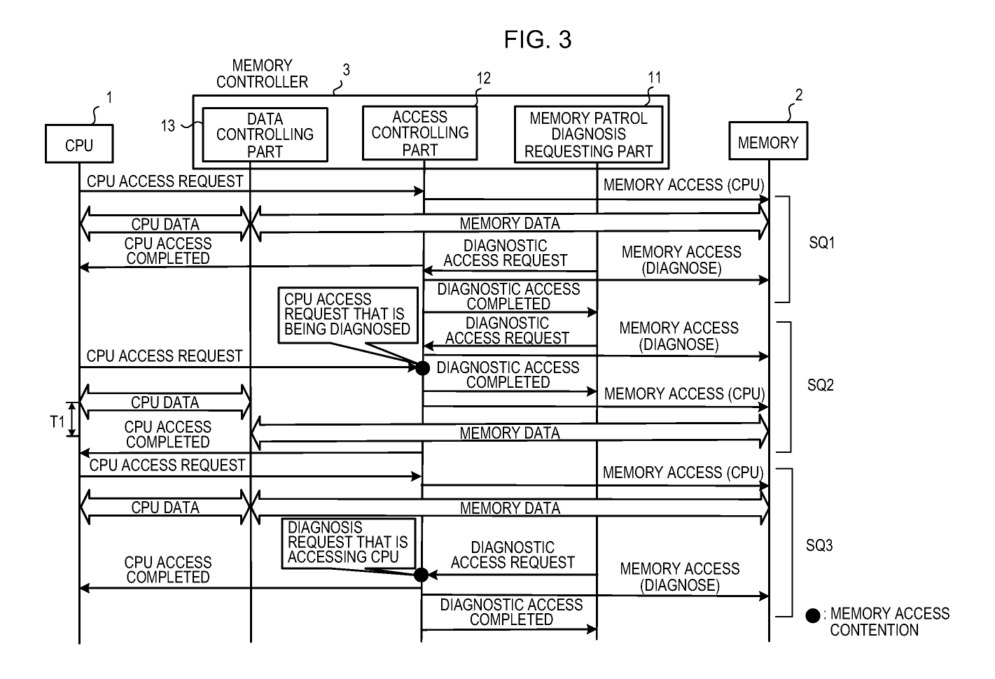

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout. The embodiments will be described below with reference to the drawings.

Configuration of Memory Controller:

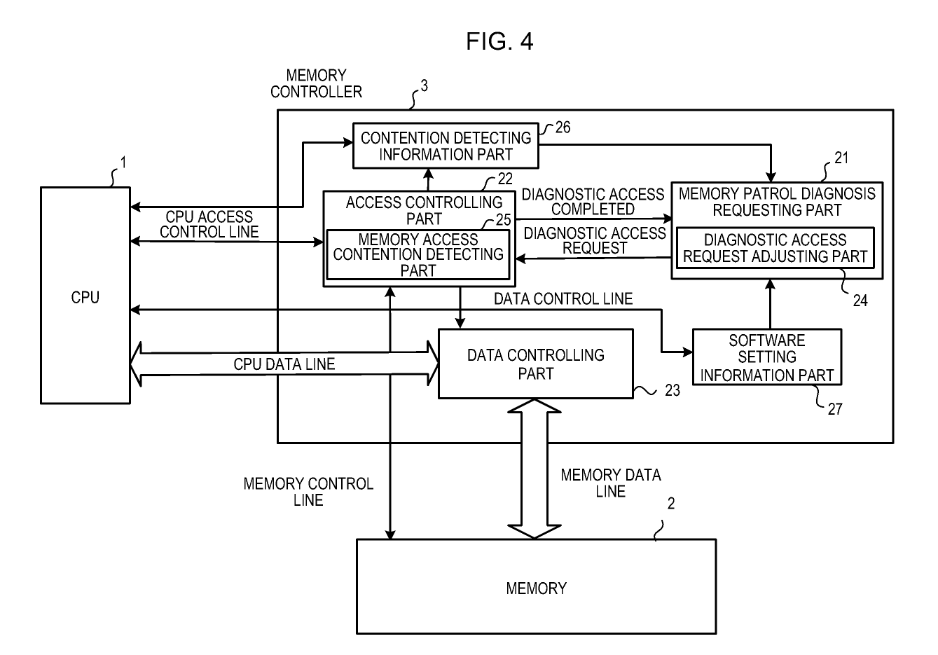

FIG. 4 is a block diagram of a memory controller according to an embodiment. A memory patrol diagnosis requesting part 21 in a memory controller 3 in FIG. 4 corrects one-bit error and detects uncorrectable memory errors in a memory 2. An access controlling part 22 selects either of a memory access from a CPU 1 or a memory access from the memory patrol diagnosis requesting part 21. An access controlling part 22 reports the selection information to a data controlling part 23. The data controlling part 23 switches the memory access based on the information.

When the memory access from the CPU 1, which is shown in FIG. 4, and the memory access from the memory patrol diagnosis requesting part 21 contend with each other on the access controlling part 22, the access controlling part 22 selects either memory access to the process according to the contention timing. The access controlling part 22 sends the selection information to the data controlling part 23. The memory controller according to the embodiment processes the memory access from the CPU 1 and the memory access from the memory patrol diagnosis requesting part 21 in the abovementioned manner.

The memory patrol diagnosis requesting part 21 in FIG. 4 is provided with a diagnostic access request adjusting part 24. The access controlling part 22 is provided with a memory access contention detecting part 25. In the memory controller 3, a contention detecting information part 26 and a software setting information part 27 are provided. An embodiment without the memory access contention detecting part 25 and the contention detecting information part 26 is also possible.

When the memory access from the CPU 1 and the memory access from the memory patrol diagnosis requesting part 21 contend with each other, the memory access contention detecting part 25 shown in FIG. 4 detects the contention. The memory access contention detecting part 25 sends collision occurrence information to the contention detecting information part 26. A collision rate is calculated in the contention detecting information part 26. The collision rate in the contention detecting information part 26 is referenced by the software program that is running in the CPU 1 or the diagnostic access request adjusting part 24.

In the software setting information part 27 shown in FIG. 4, cycle parameter information, threshold information, load information and the like are set by the software program that is running in the CPU 1.

The diagnostic access request adjusting part 24 shown in FIG. 4 periodically checks the software setting information part 27 or the contention detecting information part 26 and the software setting information part 27. For example, the hardware (for example, the diagnostic access request adjusting part 24) of the memory controller 3 automatically adjusts and changes a cycle of intermittent execution of the diagnostic access request to the access controlling part 22 based on the collision rate in the contention detecting information part 26 and collision rate threshold information in the software setting information part 27.

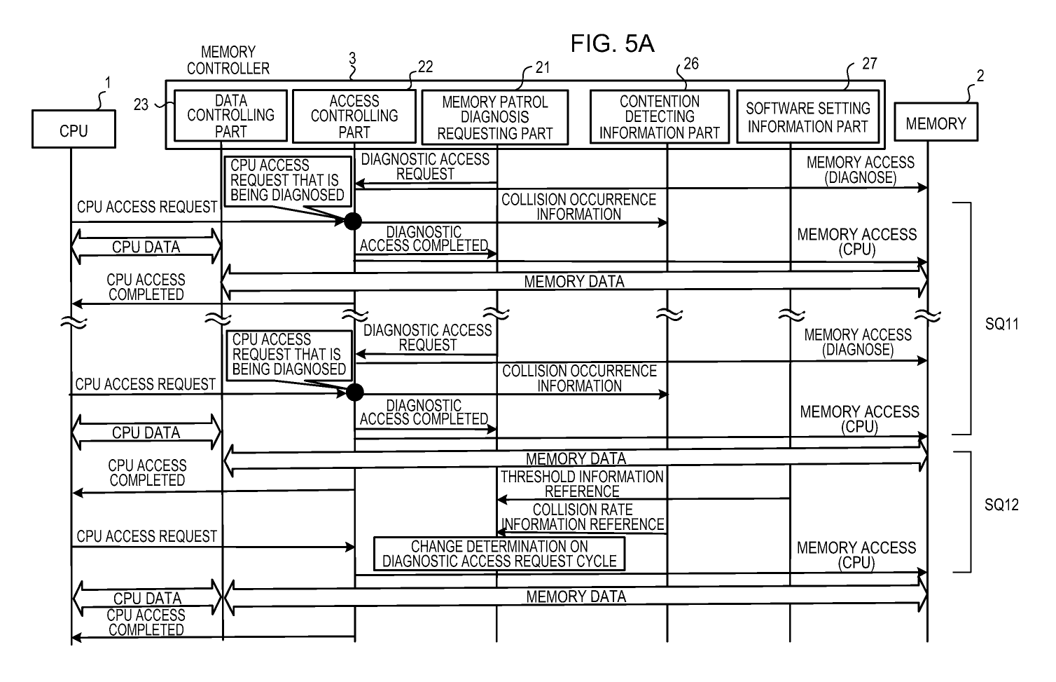

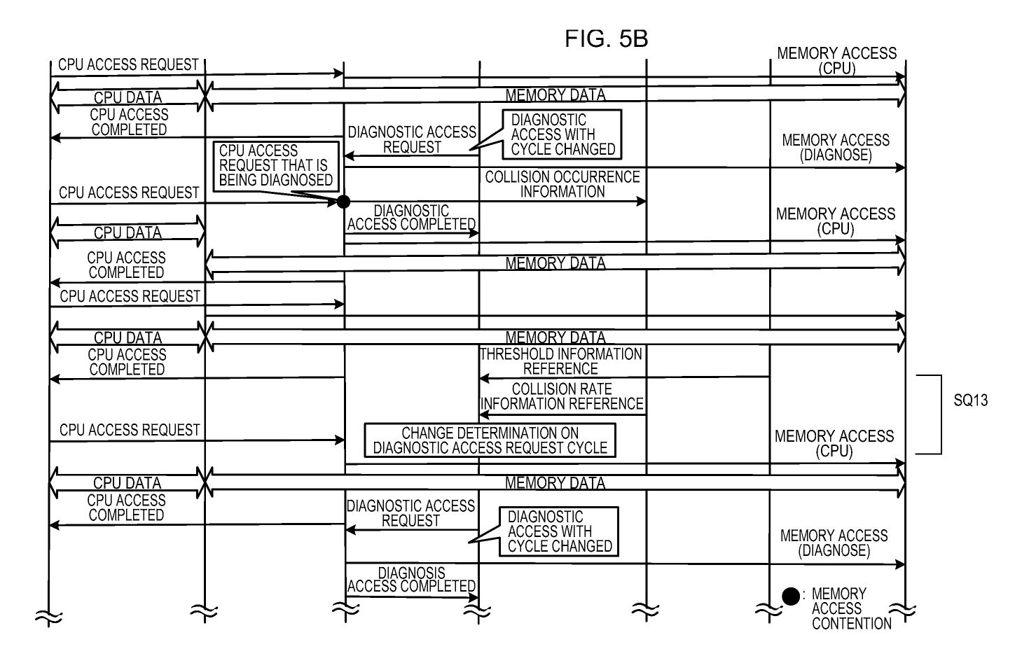

FIGS. 5A and 5B show processing sequences of a memory controller according to the embodiment. In FIG. 5A, in a sequence SQ11 at the initial stage, CPU access requests and diagnostic access requests are frequently issued. When the CPU access request and the diagnostic access request collide against each other, the access controlling part 22 sends the collision occurrence information to the contention detecting information part 26.

In sequences SQ 12 and SQ13 shown in FIGS. 5A and 5B, the memory patrol diagnosis requesting part 21 periodically references the collision rate threshold information in the software setting information part 27 and the collision rate in the contention detecting information part 26 and performs change determination on the diagnostic access request cycle. The memory patrol diagnosis requesting part 21 periodically performs the change determination on the diagnostic access request cycle and optimally changes the cycle of the diagnostic access request.

Even if the diagnostic access request is issued after the change determination is performed on the diagnostic access request cycle, it may collide against the memory access from the CPU 1. The memory controller according to the embodiment, however, can decide an optimal diagnostic access cycle for reducing the number of collisions in a certain time period as few as possible by checking the collision rate in a certain time period.

### First Embodiment

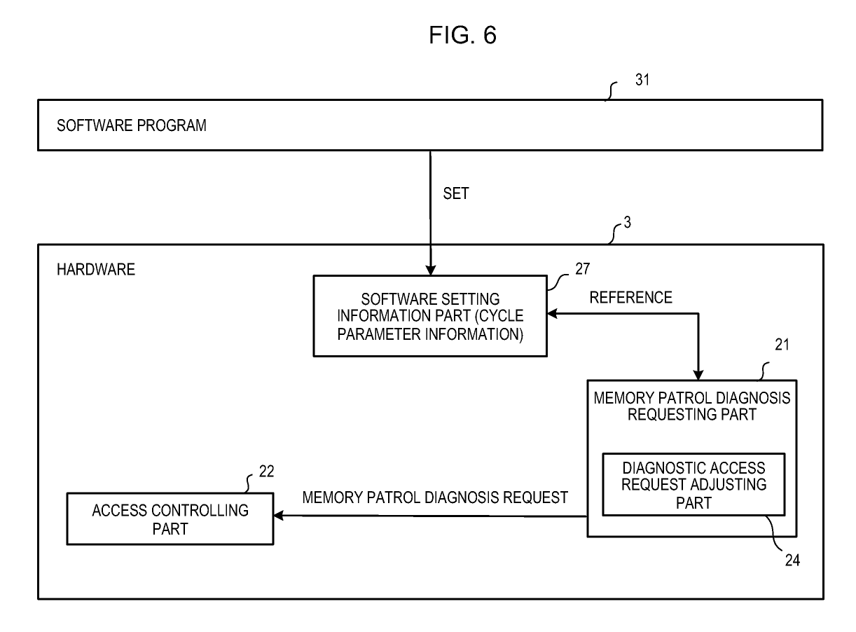

FIG. 6 is a block diagram for illustrating a first embodiment. The memory patrol diagnosis requesting part 21 shown in FIG. 6 requests the access controlling part 22 to perform memory patrol diagnosing.

A software program 31 shown in FIG. 6, which is running in the CPU 1, decides a cycle parameter according to the usage of the CPU 1 or the number of service loads that is being checked. The software program 31 which is running in the CPU 1 sets the decided cycle parameter into the software setting information part 27 in the memory controller 3 as the cycle parameter information. The cycle parameter information in the software setting information part 27 shown in FIG. 6 is a parameter which is used in deciding a cycle of intermittent execution of memory patrol diagnosis requests. The cycle parameter information is referenced by the diagnostic access request adjusting part 24.

The diagnostic access request adjusting part 24 references the cycle parameter information that is set by the software program 31, which is running in the CPU 1, into the software setting information part 27. The diagnostic access request adjusting part 24 takes the referenced cycle parameter information as the cycle of intermittent execution of the diagnostic access request. The access controlling part 22 performs the memory access from the CPU 1. If no memory access is requested from the CPU 1, the access controlling part 22 performs the memory access according to the memory patrol diagnosis request.

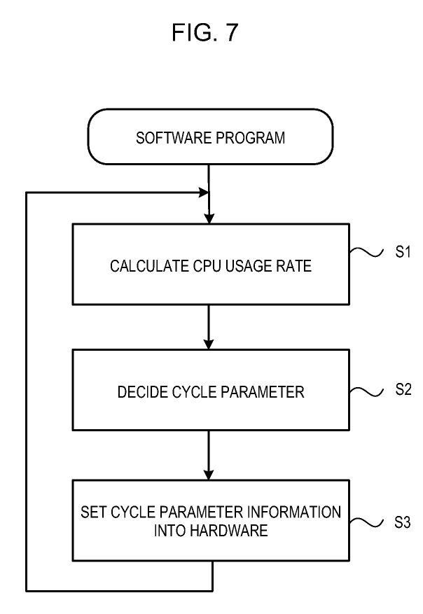

FIG. 7 is a flowchart of a process to be executed by a software program 31 according to the first embodiment. The software program 31 shown in FIG. 7 calculates the usage rate of the CPU 1 at operation S1. At operation S2, the software program 31 decides the cycle parameter.

The software program 31 has a table, in which cycle parameters corresponding to CPU usage rates are set in advance. The software program 31 decides the cycle parameter by referencing the table. Next at operation S3, the software program 31 sets the decided cycle parameter into the software setting information part 27 in the memory controller 3 as the cycle parameter information.

### Modification of First Embodiment

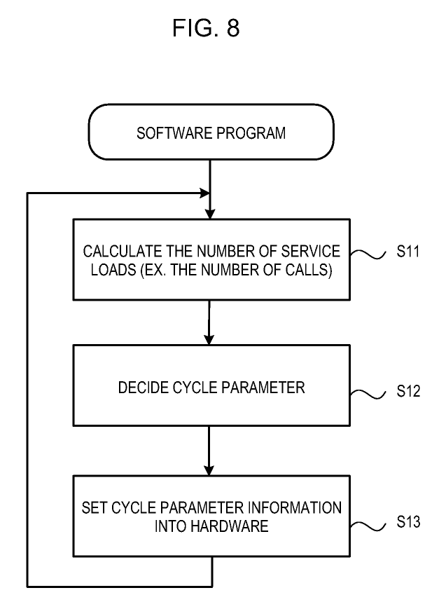

FIG. 8 is a flowchart of a process to be executed by a software program 31 according to a modification of the first embodiment. The modification uses the number of service loads instead of the CPU usage rate. If the CPU 1 is performing call control, the number of calls is used as an example of the number of service loads.

The software program 31 shown in FIG. 8 calculates the number of service loads at operation S11. At operation S12, The software program 31 decides the cycle parameter. The software program 31 has a table, in which cycle parameters corresponding to the number of service loads are set in advance. The software program 31 decides the cycle parameter by referencing the table. Next at operation S13, the software program 31 sets the decided cycle parameter into the software setting information part 27 in the memory controller 3 as the cycle parameter information.

### Second Embodiment

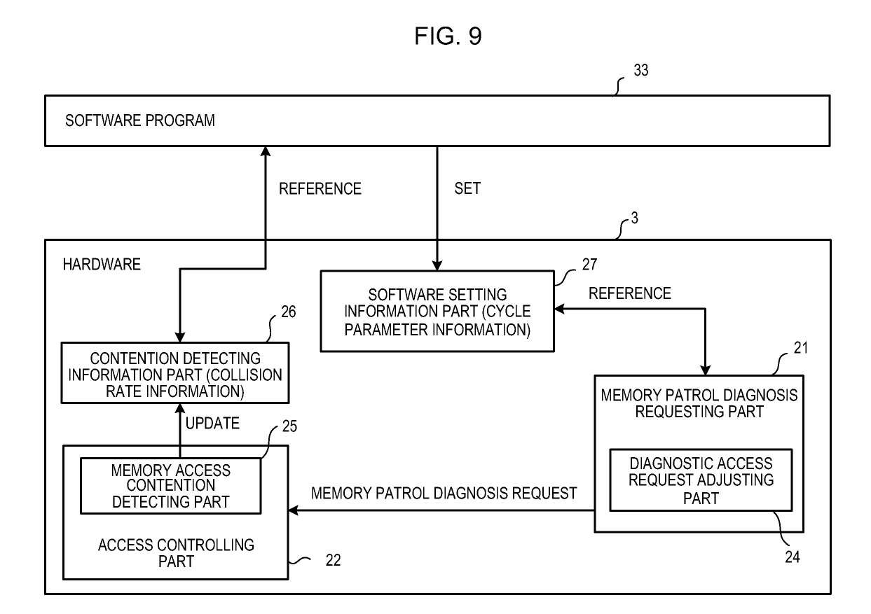

FIG. 9 is a block diagram for illustrating a second embodiment. The memory patrol diagnosis requesting part 21 shown in FIG. 9 requests the access controlling part 22 to perform the memory patrol diagnosing.

The access controlling part 22 shown in FIG. 9 performs the memory access from the CPU 1. If no memory access is requested from the CPU 1, the access controlling part 22 performs the memory access according to the memory patrol diagnosis request. The memory access contention detecting part 25 in the access controlling part 22 checks the presence of the contention between the memory access from the CPU 1 and the memory access from the memory patrol diagnosis requesting part 21. Specifically, the memory access contention detecting part 25 checks the presence of the memory access collisions and sends the collision occurrence information to the contention detecting information part 26. The contention detecting information part 26 calculates the collision rate.

A software program 33 shown in FIG. 9, which is running in the CPU 1 checks collision rate information in the contention detecting information part 26 in the memory controller 3. The software program 33 sets a cycle parameter, which is decided according to the collision rate information, into the software setting information part 27 in the memory controller 3 as the cycle parameter information. The software program 33 has a table, in which cycle parameters corresponding to the collision rate information are set in advance. The software program 33 decides the cycle parameter by referencing the table.

The diagnostic access request adjusting part 24 shown in FIG. 9 references the cycle parameter information that is set by the software program 33, which is running in the CPU 1, into the software setting information part 27. The diagnostic access request adjusting part 24 makes the referenced cycle parameter information as the cycle of intermittent execution of the diagnostic access request. The access controlling part 22 executes the memory access from the CPU 1. If no memory access is requested from the CPU 1, the access controlling part 22 executes the memory access according to the memory patrol diagnosis request.

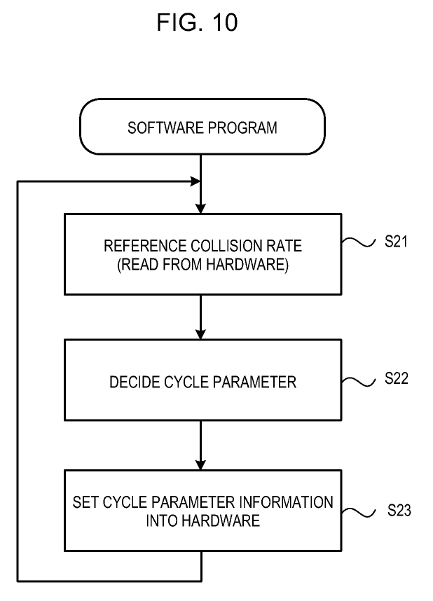

FIG. 10 is a flowchart of a process to be executed by the software program 33 according to the second embodiment. The software program 33 shown in FIG. 10 references the collision rate information in the contention detecting information part 26 in the memory controller 3 at operation S21. At operation S22, the software program 33 decides the cycle parameter.

The software program 33 has a table, in which cycle parameters corresponding to the collision rate are set in advance. The software program 33 decides the cycle parameter by referencing the table. Next at operation S23, the software program 33 sets the cycle parameter which is decided at the previous operation into the software setting information part 27 in the memory controller 3 as the cycle parameter information.

### Third Embodiment

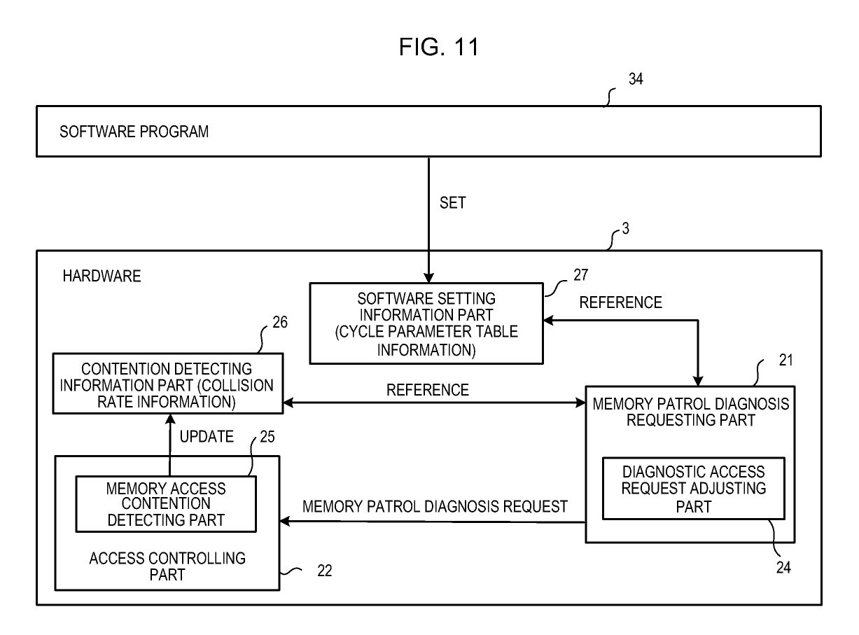

FIG. 11 is a block diagram for illustrating a third embodiment. The memory patrol diagnosis requesting part 21 shown in FIG. 11 requests the access controlling part 22 to perform memory patrol diagnosing.

The access controlling part 22 shown in FIG. 11 executes the memory access from the CPU 1. If no memory access is requested from the CPU 1, the access controlling part 22 executes the memory access according to the memory patrol diagnosis request. The memory access contention detecting part 25 in the access controlling part 22 checks the presence of the contention between the memory access from the CPU 1 and the memory access from the memory patrol diagnosis requesting part 21. The memory access contention detecting part 25 checks the presence of the memory access collisions and sends the collision occurrence information to the contention detecting information part 26. The contention detecting information part 26 calculates the collision rate.

A software program 34 shown in FIG. 11, which is running in the CPU 1, sets a cycle parameter table, which is prepared therein, into the software setting information part 27 in the memory controller 3 as the cycle parameter table information.

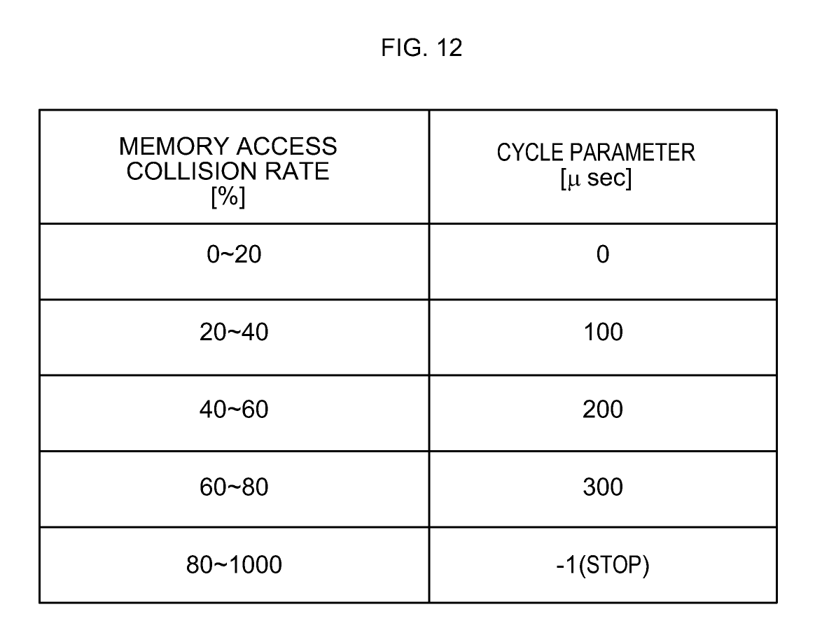

The cycle parameter table information in the software setting information part 27 is a table which is used in deciding a cycle of intermittent execution of memory patrol diagnosis requests. The cycle parameter table information is referenced by the diagnostic access request adjusting part 24. As shown in FIG. 12, the cycle parameter table information includes memory access collision rates [%] and cycle parameters [μsec] corresponding to each other.

As shown in FIG. 12, if the collision rate is 0-20%, the cycle parameter is 0 μsec. That means the memory patrol diagnosis requests are not performed intermittently. If the collision rate is 20-40%, the cycle parameter is 100 μsec. That means the memory patrol diagnosis request is performed for each 100 μsec. If the collision rate is 80-100%, the cycle parameter is −1. That means the memory patrol diagnosis request is stopped.

The diagnostic access request adjusting part 24 shown in FIG. 11 references the collision rate information in the contention detecting information part 26. The diagnostic access request adjusting part 24 references the cycle parameter table information in the software setting information part 27 with the collision rate that is obtained by referencing the collision rate information. Then, the diagnostic access request adjusting part 24 takes the referenced cycle parameter table information as the cycle of intermittent execution of the diagnostic access request. The access controlling part 22 executes the memory access from the CPU 1. If no memory access is requested from the CPU 1, the access controlling part 22 executes the memory access according to the memory patrol diagnosis request.

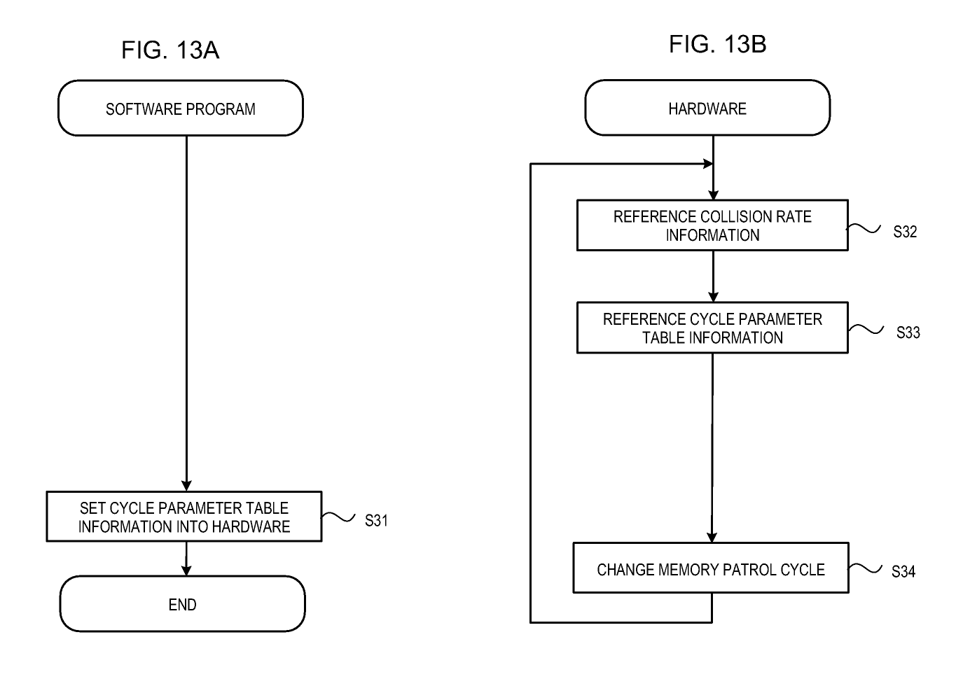

FIGS. 13A and 13B are flowcharts of processes to be executed by the software program 34 and the memory controller 3 shown in FIG. 11 according to the third embodiment. In FIG. 13A, the software program 34, which is running in the CPU 1, sets the cycle parameter table, which is prepared therein, into the software setting information part 27 in the memory controller 3 as the cycle parameter table information at operation S31. The process is initialized when the power is turned on, for example.

In FIG. 13B, the diagnostic access request adjusting part 24 of the memory controller 3 obtains the collision rate information by referencing the contention detecting information part 26 at operation S32. At operation S33, the diagnostic access request adjusting part 24 obtains the cycle parameter corresponding to the collision rate by referencing the cycle parameter table information by using the obtained collision rate. Next at operation S34, the diagnostic access request adjusting part 24 takes the abovementioned cycle parameter as the cycle of intermittent execution of the diagnostic access request, and returns to operation S32.

### Fourth Embodiment

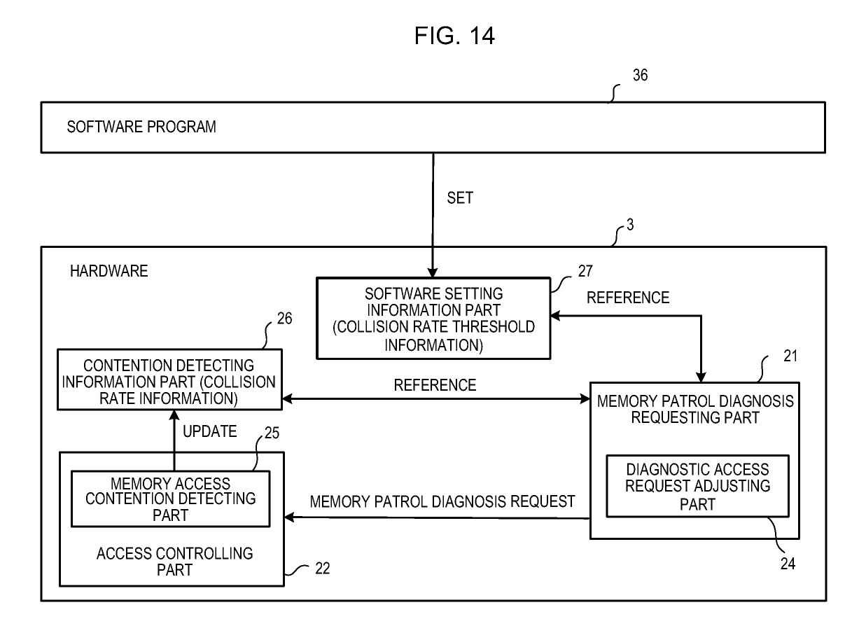

FIG. 14 is a block diagram for illustrating a fourth embodiment. The memory patrol diagnosis requesting part 21 shown in FIG. 14 requests the access controlling part 22 to perform the memory patrol diagnosing.

The access controlling part 22 performs the memory access from the CPU 1. If no memory access is requested from the CPU 1, the access controlling part 22 executes the memory access according to the memory patrol diagnosis request. The memory access contention detecting part 25 in the access controlling part 22 checks the presence of the contention between the memory access from the CPU 1 and the memory access from the memory patrol diagnosis requesting part 21. The memory access contention detecting part 25 checks the presence of memory access collisions and sends the collision occurrence information to the contention detecting information part 26. The contention detecting information part 26 calculates the collision rate.

A software program 36 shown in FIG. 14 sets a collision rate threshold, which is prepared therein, into the software setting information part 27 in the memory controller 3 as collision rate threshold information.

The collision rate threshold information in the software setting information part 27 shown in FIG. 14 is a threshold of the collision rate which is used in deciding a cycle of intermittent execution of memory patrol diagnosis requests (for example, a fixed value around 20%). The collision rate threshold information is referenced by the diagnostic access request adjusting part 24.

The diagnostic access request adjusting part 24 references the collision rate information in the contention detecting information part 26 and the collision rate threshold information in the software setting information part 27. The diagnostic access request adjusting part 24 compares the collision rate therein and the collision rate threshold. If the collision rate exceeds the collision rate threshold, the diagnostic access request adjusting part 24 extends the cycle of intermittent execution by a predetermined amount (for example, 100 μsec) to adjust the collision rate lower than the collision rate threshold. If the collision rate is lower than the collision rate threshold, the diagnostic access request adjusting part 24 shortens the cycle of intermittent execution by a predetermined amount (for example, 100 μsec) to adjust the collision rate getting nearer to the collision rate threshold.

The access controlling part 22 executes the memory access from the CPU 1. If no memory access is requested from the CPU 1, the access controlling part 22 executes the memory access according to the memory patrol diagnosis request.

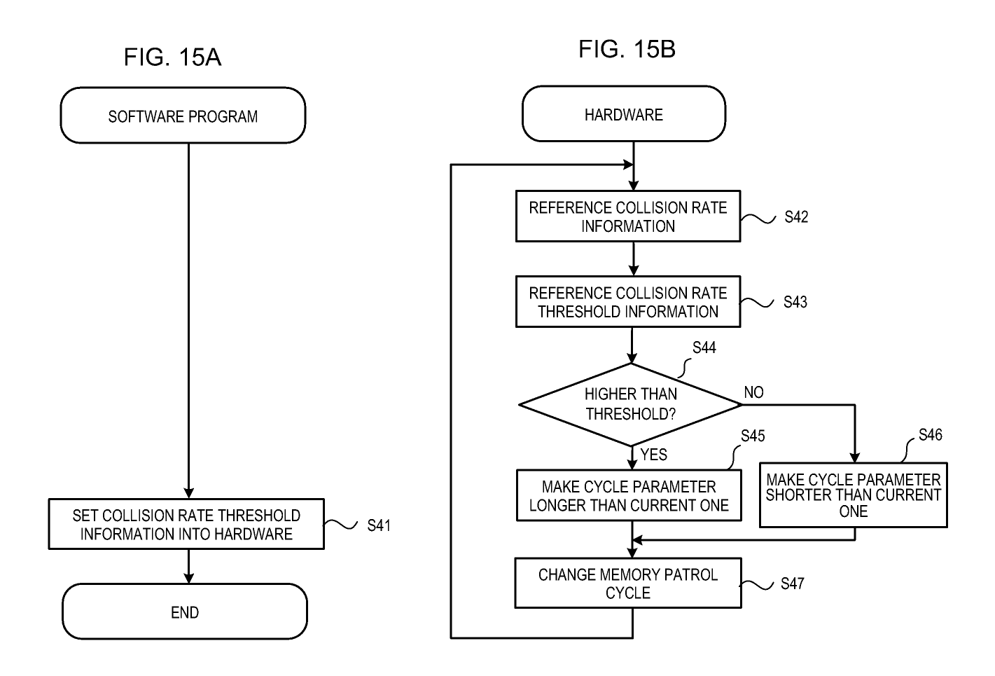

FIGS. 15A and 15B are flowcharts of processes to be executed by the software program 34 and the memory controller 3 according to the fourth embodiment. In FIG. 15A, the software program 36 sets the collision rate threshold, which is prepared therein, into the software setting information part 27 in the memory controller 3 as the collision rate threshold information at operation S41. The process is initialized as the power is turned on, for example.

In FIG. 15B, the diagnostic access request adjusting part 24 of the memory controller 3 obtains the collision rate by referencing the collision rate information in the contention detecting information part 26 at operation S42. At operation S43, the diagnostic access request adjusting part 24 obtains the collision rate threshold by referencing the collision rate threshold information in the software setting information part 27. At operation S44, the diagnostic access request adjusting part 24 compares the collision rate and the collision rate threshold. If the collision rate>the collision rate threshold at operation S44, the diagnostic access request adjusting part 24 extends the cycle of intermittent execution by a predetermined amount at operation S45. If the collision rate≦the collision rate threshold at operation S44, the diagnostic access request adjusting part 24 shortens the cycle of intermittent execution by a predetermined amount at operation S46. Then at operation S47, the diagnostic access request adjusting part 24 changes the cycle of the intermittent execution of the diagnostic access request, and returns to operation S42.

The processing sequence shown in FIGS. 5A and 5B illustrates the fourth embodiment.

### Fifth Embodiment

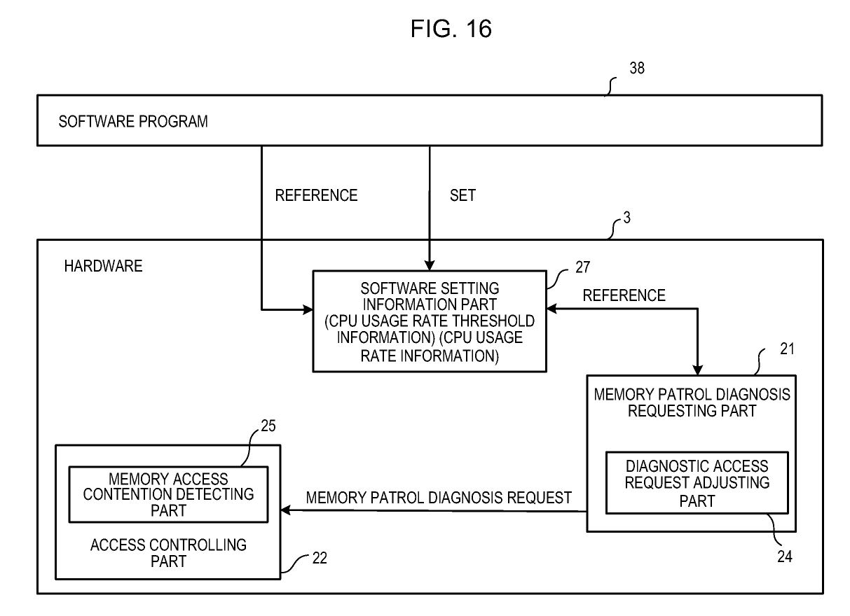

FIG. 16 is a block diagram for illustrating a fifth embodiment. The memory patrol diagnosis requesting part 21 shown in FIG. 16 requests the access controlling part 22 to perform memory patrol diagnosing.

The access controlling part 22 executes the memory access from the CPU 1. If no memory access is requested from the CPU 1, the access controlling part 22 executes the memory access according to the memory patrol diagnosis request.

A software program 38 sets a CPU usage rate threshold, which is prepared therein, into the software setting information part 27 in the memory controller 3 as CPU usage rate threshold information. The software program 38 periodically calculates the usage rate of the CPU 1 and sets it to the CPU usage rate information into the software setting information part 27 in the memory controller 3. The CPU usage rate threshold information in the software setting information part 27 is a threshold of the CPU usage rate which is used in deciding a cycle of intermittent execution of memory patrol diagnosis requests (for example, a fixed value around 40%). The CPU usage rate threshold information is referenced by the diagnostic access request adjusting part 24.

The diagnostic access request adjusting part 24 references the CPU usage rate information and the CPU usage rate threshold information in the software setting information part 27. The diagnostic access request adjusting part 24 compares the CPU usage rate and the CPU usage rate threshold. If the CPU usage rate exceeds the CPU usage rate threshold, the diagnostic access request adjusting part 24 extends the cycle of intermittent execution by a predetermined amount (for example, 1 msec). If the CPU usage rate is lower than the CPU usage rate threshold, the diagnostic access request adjusting part 24 shortens the cycle of intermittent execution by a predetermined amount (for example, 1 msec).

The access controlling part 22 executes the memory access from the CPU 1. If no memory access is requested from the CPU 1, the access controlling part 22 executes the memory access according to the memory patrol diagnosis request.

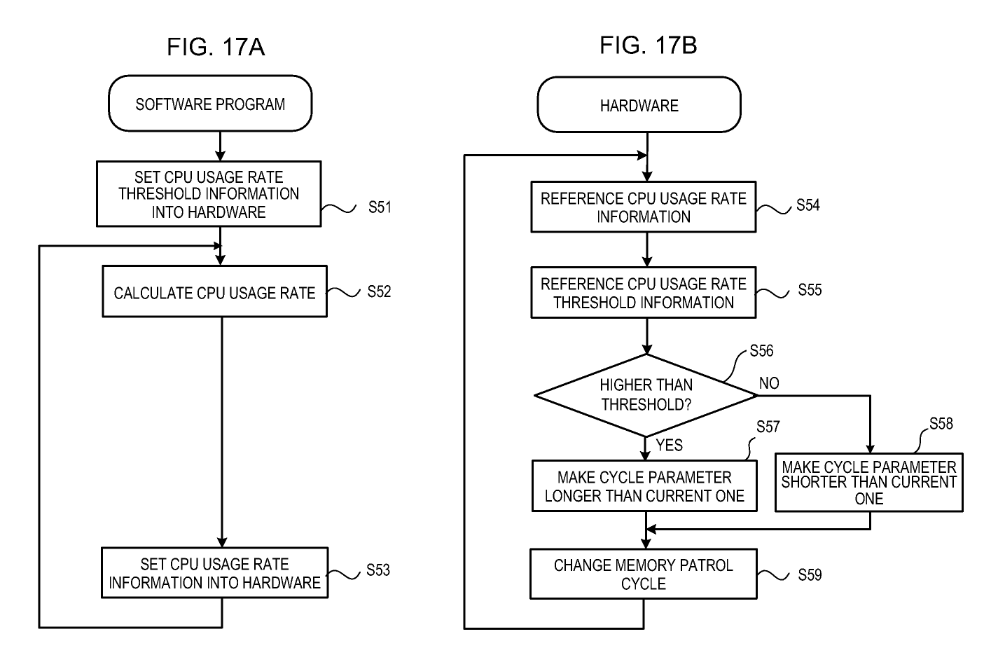

FIGS. 17A and 17B are flowcharts of processes to be executed by the software program 38 and the memory controller 3 according to the fifth embodiment. In FIG. 17A, the software program 38 sets the CPU usage rate threshold, which is prepared therein, into the software setting information part 27 in the memory controller 3 as the CPU usage rate threshold information at operation S51. Next at operation S52, the software program 38 calculates the usage rate of the CPU 1. At operation S53, the software program 38 sets the usage rate of the CPU 1 into the software setting information part 27 in the memory controller 3 as CPU usage rate information 40.

In FIG. 17B, the diagnostic access request adjusting part 24 of the memory controller 3 obtains the CPU usage rate by referencing the CPU usage rate information in the software setting information part 27 at operation S54. At operation S55, the diagnostic access request adjusting part 24 obtains the CPU usage rate threshold by referencing the CPU usage rate threshold information in the software setting information part 27. At operation S56, the diagnostic access request adjusting part 24 compares the CPU usage rate and the CPU usage rate threshold. If the CPU usage rate>the CPU usage rate threshold at operation S56, the diagnostic access request adjusting part 24 extends the cycle of intermittent execution by a predetermined amount at operation S57. If the CPU usage rate≦the CPU usage rate threshold at operation S56, the diagnostic access request adjusting part 24 shortens the cycle of intermittent execution by a predetermined amount at operation S58. Then at operation S59, the diagnostic access request adjusting part 24 changes the cycle of the intermittent execution, and returns to operation S54.

### Modification of Fifth Embodiment

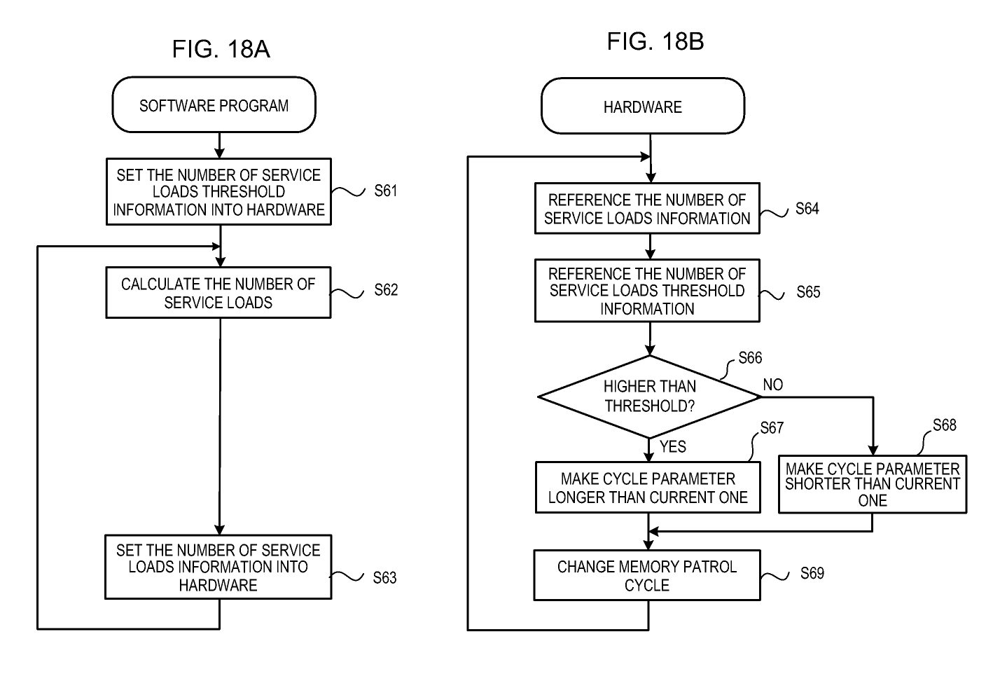

FIGS. 18A and 18B are flowcharts of processes to be executed by the software program 38 and the memory controller 3 according to a modification of the fifth embodiment. The modification uses the number of service loads instead of the CPU usage rate. If the CPU 1 is performing call control, the number of calls is used as an example of the number of service loads.

In FIG. 18A, the software program 38 sets a number of service loads threshold, which is prepared therein, into the software setting information part 27 in the memory controller 3. Next at operation S62, the software program 38 calculates the number of service loads. At operation S63, the software program 38 sets the number of service loads into the software setting information part 27 in the memory controller 3.

In FIG. 18B, the diagnostic access request adjusting part 24 of the memory controller 3 obtains the number of service loads by referencing the number of service loads information at operation S64. At operation S65, the diagnostic access request adjusting part 24 obtains the number of service loads threshold by referencing the number of service loads threshold information. At operation S66, the diagnostic access request adjusting part 24 compares the number of service loads and the number of service loads threshold. If the number of service loads>the number of service loads threshold at operation S66, the diagnostic access request adjusting part 24 extends the cycle of intermittent execution by a predetermined amount at operation S67. If the number of service loads≦the number of service loads threshold at operation S66, the diagnostic access request adjusting part 24 shortens the cycle of intermittent execution by a predetermined amount at operation S68. Then at operation S69, the diagnostic access request adjusting part 24 changes the cycle of the intermittent execution, and returns to operation S64.

The abovementioned embodiments can improve the system performance as they can restrain degradation of the system performance caused by the memory access contention between the CPU 1 and the memory patrol diagnosis requesting part 21, while keeping the functions of memory patrol diagnosis requesting part 21 for correcting a one-bit error and detecting an uncorrectable memory error in the memory 2. As the embodiments can employ multiple types of information including the collision rate, the CPU usage rate and the number of service loads, they can make the memory patrol function suitable for the characteristics of the system concerned.

The abovementioned embodiments use the memory patrol diagnosis requesting part 21 as an example of a memory diagnosing part, the software setting information part 27 as an example of an information setting part, and the diagnostic access request adjusting part 24 as an example of a cycle adjusting part.

In addition, the abovementioned embodiments use the memory access contention detecting part 25 and the contention detecting information part 26 as examples of a collision rate calculating part.

The memory controller of the embodiments can restrain degradation of the system performance by reducing the frequency of contentions between the memory access according to the diagnostic access request and the memory access from the CPU.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A memory controller comprising:
a memory diagnosing part for controlling access from a CPU to a memory, and accessing and diagnosing said memory;
an information setting part for setting cycle information according to a loaded condition of said CPU; and
a cycle adjusting part for adjusting a cycle for said memory diagnosing part to access said memory based on the cycle information of said information setting part.

2. A processor system comprising a memory controller that controls a CPU and a memory, wherein said memory controller comprises:
a memory diagnosing part for controlling access from a CPU to a memory, and accessing and diagnosing said memory;
an information setting part for setting cycle information according to a loaded condition of said CPU; and
a cycle adjusting part for adjusting a cycle for said memory diagnosing part to access said memory based on the cycle information of said information setting part.

3. The processor system according to claim 2, wherein said memory controller further comprises:
a collision rate calculating part for detecting a collision between access from said memory diagnosing part to the memory and access from said CPU to the memory and calculating a collision rate;
an information setting part for setting cycle information according to the collision rate of said collision rate calculating part; and
a cycle adjusting part for adjusting a cycle for said memory diagnosing part to access said memory based on the cycle information of said information setting part.

4. The processor system according to claim 2, wherein said memory controller further comprises:
a collision rate calculating part for detecting a collision between access from said memory diagnosing part to the memory and access from said CPU to the memory and calculating a collision rate;
an information setting part for setting a cycle information table according to a plurality of collision rates; and
a cycle adjusting part for adjusting a cycle for said memory diagnosing part to access said memory based on the cycle information that can be obtained by referencing said cycle information table with the collision rate of said collision rate calculating part.

5. The processor system according to claim 2, wherein said memory controller further comprises:
a collision rate calculating part for detecting a collision between access from said memory diagnosing part to the memory and access from said CPU to the memory and calculating a collision rate;
an information setting part for setting a collision rate threshold; and
a cycle adjusting part for adjusting a cycle for said memory diagnosing part to access said memory according to a result of a comparison between the collision rate of said collision rate calculating part and the collision rate threshold of said information setting part.

6. The processor system according to claim 2, wherein said memory controller further comprises:
an information setting part for setting the loaded condition of said CPU and a loaded condition threshold; and
a cycle adjusting part for adjusting a cycle for said memory diagnosing part to access said memory according to a result of a comparison between the loaded condition of said information setting part and the loaded condition threshold of said information setting part.

7. The processor system according to claim 2, wherein said loaded condition is a CPU usage rate.

8. The processor system according to claim 2, wherein said loaded condition is the number of service loads.

9. The processor system according to claim 6, wherein said loaded condition is a CPU usage rate and said loaded condition threshold is a CPU usage rate threshold.

10. The processor system according to claim 6, wherein said loaded condition is the number of service loads and said loaded condition threshold is the number of service loads threshold.

11. The memory controller according to claim 1, comprising:
a collision rate calculating part for detecting a collision between access from said memory diagnosing part to the memory and access from said CPU to the memory and calculating a collision rate;
an information setting part for setting cycle information according to the collision rate of said collision rate calculating part; and
a cycle adjusting part for adjusting a cycle for said memory diagnosing part to access said memory based on the cycle information of said information setting part.

12. The memory controller according to claim 1, the memory controller comprising:
a collision rate calculating part for detecting a collision between access from said memory diagnosing part to the memory and access from said CPU to the memory and calculating a collision rate;
an information setting part for setting a cycle information table according to a plurality of collision rates; and
a cycle adjusting part for adjusting a cycle for said memory diagnosing part to access said memory based on the cycle information that can be obtained by referencing said cycle information table with the collision rate of said collision rate calculating part.

13. The memory controller according to claim 1, comprising:
a collision rate calculating part for detecting a collision between access from said memory diagnosing part to the memory and access from said CPU to the memory and calculating a collision rate;
an information setting part for setting a collision rate threshold; and
a cycle adjusting part for adjusting a cycle for said memory diagnosing part to access said memory according to a result of a comparison between the collision rate of said collision rate calculating part and the collision rate threshold of said information setting part.

14. The memory controller according to claim 1, comprising:
an information setting part for setting the loaded condition of said CPU and a loaded condition threshold; and
a cycle adjusting part for adjusting a cycle for said memory diagnosing part to access said memory according to a result of a comparison between the loaded condition of said information setting part and the loaded condition threshold of said information setting part.

15. A method of memory control, comprising:
controlling access from a CPU to a memory;
accessing and diagnosing the memory;
setting cycle information according to a loaded condition of the CPU; and
adjusting a cycle for accessing the memory based on the cycle information.

16. The method of memory control of claim 15, comprising further:
detecting a collision between accesses to the memory for diagnosis and access from the CPU;
calculating a collision rate;
setting the cycle information according to the collision rate; and
adjusting the cycle for the accesses to the memory for diagnosis based on the cycle information.

17. The method of memory control of claim 15, comprising further:
detecting a collision between accesses to the memory for diagnosis and access from the CPU;
calculating a collision rate;
setting the cycle information according to a plurality of collision rates; and
adjusting the cycle for the accesses to the memory for diagnosis based on the cycle information.

18. The method of memory control of claim 15, comprising further:
detecting a collision between accesses to the memory for diagnosis and access from the CPU;
calculating a collision rate;
setting a collision rate threshold; and
adjusting the cycle for the accesses to the memory for diagnosis according to a result of a comparison between the collision rate and the collision rate threshold.

19. The method of memory control of claim 15, comprising further:
setting the loaded condition of the CPU and a loaded condition threshold; and
adjusting the cycle for the accesses to the memory for diagnosis according to a result of a comparison between the loaded condition and the loaded condition threshold.
